(19) United States
(12) Patent Application Publication
(10) Pub. No.: US 2020/0035070 A1
(43) Pub. Date: Jan. 30, 2020

(54) REGISTRATION SETTLEMENT APPARATUS

(71) Applicant: TOSHIBA TEC KABUSHIKI KAISHA, Tokyo (JP)

(72) Inventors: Yuichi Ogawa, Izunokuni Shizuoka (JP); Takashi Muraoka, Sunto Shizuoka (JP)

(21) Appl. No.: 16/509,641

(22) Filed: Jul. 12, 2019

(30) Foreign Application Priority Data
Jul. 25, 2018 (JP) 2018-139620

(51) Int. Cl. G07G 1/00; G06Q 20/20

(52) U.S. Cl. CPC G07G 1/0036; G07G 1/0009; G06Q 20/202

(57) ABSTRACT

A registration settlement apparatus comprises a first display device for performing display for a store clerk; a second display device for performing display for a customer; a switching module for switching an operation mode between a first operation mode in which the store clerk performs registration operation of a purchased commodity and the customer performs settlement operation on a payment amount of the purchased commodity and a second operation mode in which the customer performs operations from the registration to the settlement; and a first control module for controlling the first display device to display an image indicating contents of an error at the time the first operation mode is selected, and controlling the second display device to display an image for instructing to call the store clerk at the time the second operation mode is selected if the error occurs in the registration operation.

### CROSS-REFERENCE TO RELATED APPLICATION

This application is based upon and claims the benefit of priority from Japanese Patent Application No. 2018-139620, filed on Jul. 25, 2018, the entire contents of which are incorporated herein by reference.

### FIELD

Embodiments described herein relate generally to a registration settlement apparatus.

### BACKGROUND

In a retail store such as a supermarket, a store clerk and a customer face each other across a checkout counter, and a registration settlement apparatus on the checkout counter is operated by the store clerk to register commodities that the customer purchases, and then is operated by the customer to perform settlement on payment amount of the purchased commodities. In such a registration settlement apparatus, much effort is made to arrange the apparatus so that the customer can also register a purchased commodity. As a result, the registration settlement apparatus can be properly used in two ways: a so-called semi-self-service operation in which the store clerk performs registration of the purchased commodity and the customer performs settlement on the payment amount of the purchased commodity, and a so-called full-self-service operation in which the customer performs operations from registration to settlement.

However, to use the registration settlement apparatus in two ways as described above, when an error occurs, it is required to timely and properly notify the store clerk or the customer of occurrence of the error to quickly and appropriately handle the error.

### DESCRIPTION OF THE DRAWINGS

FIG. 1 is a diagram illustrating an overall configuration of a POS system including a POS terminal according to an embodiment;

FIG. 2 is a perspective view schematically illustrating an external appearance of the POS terminal shown in FIG. 1;

FIG. 3 is a block diagram illustrating a circuit configuration of main components of the POS terminal shown in FIG. 1;

FIG. 4 is a flowchart depicting procedures of information processing executed by a processor shown in FIG. 3 in response to an operation on a mode switching button;

FIG. 5 is a flowchart depicting procedures of error processing executed by the processor shown in FIG. 3;

FIG. 6 is a flowchart depicting procedures of error processing executed by the processor when a registration operation error occurs;

FIG. 7 is a flowchart depicting procedures of error processing executed by the processor when a settlement operation error occurs;

FIG. 8 is a flowchart depicting procedures of error processing executed by the processor when a device error occurs;

FIG. 9 is a view schematically illustrating a screen on a touch panel for store clerk and a screen on a touch panel for customer at the time of registration operation in the POS terminal operating in a semi-self-service mode;

FIG. 10 is a view schematically illustrating a screen on the touch panel for store clerk and a screen on a touch panel for customer when the registration operation error occurs in the POS terminal operating in the semi-self-service mode;

FIG. 11 is a view schematically illustrating a screen on the touch panel for store clerk and a screen on the touch panel for customer at the time of registration operation in the POS terminal operating in a full-self-service mode;

FIG. 12 is a view schematically illustrating a screen on the touch panel for store clerk and a screen on the touch panel for customer when the registration operation error occurs in the POS terminal operating in the full-self-service mode;

FIG. 13 is a view schematically illustrating a screen on the touch panel for store clerk and a screen on the touch panel for customer after a confirmation button is touched in a state shown in FIG. 12;

FIG. 14 is a view schematically illustrating a screen on the touch panel for store clerk and a screen on the touch panel for customer in an electronic money settlement operation in the POS terminal operating in the semi-self-service mode;

FIG. 15 is a view schematically illustrating a screen on the touch panel for store clerk and a screen on the touch panel for customer when an error occurs in the electronic money settlement operation in the POS terminal operating in the semi-self-service mode;

FIG. 16 is a view schematically illustrating a screen on the touch panel for store clerk and a screen on the touch panel for customer at the time of the electronic money settlement operation in the POS terminal operating in the full-self-service mode;

FIG. 17 is a view schematically illustrating a screen on the touch panel for store clerk and a screen on the touch panel for customer when an error occurs in the electronic money settlement operation in the POS terminal operating in the full-self-service mode;

FIG. 18 is a view schematically illustrating a screen on the touch panel for store clerk and a screen on the touch panel for customer while a receipt is issued in the POS terminal operating in the semi-self-service mode;

FIG. 19 is a view schematically illustrating a screen on the touch panel for store clerk and a screen on the touch panel for customer if occurring a paper jam error while the receipt is issued in the POS terminal operating in the semi-self-service mode;

FIG. 20 is a view schematically illustrating a screen on the touch panel for store clerk and a screen on the touch panel for customer after the confirmation button is touched in the state shown in FIG. 19;

FIG. 21 is a view schematically illustrating a screen on the touch panel for store clerk and a screen on the touch panel for customer while the receipt is issued in the POS terminal operating in the full-self-service mode; and

FIG. 22 is a view schematically illustrating a screen on the touch panel for store clerk and a screen on the touch panel for customer if occurring the paper jam error while the receipt is issued in the POS terminal operating in the full-self-service mode.

### DETAILED DESCRIPTION

In accordance with an embodiment, a registration settlement apparatus comprises a first display device configured to perform display for a store clerk; a second display device configured to perform display for a customer; a switching module configured to switch an operation mode of the registration settlement apparatus between a first operation mode in which the store clerk performs registration operation of a commodity that the customer purchases and the customer performs settlement operation on a payment amount of the purchased commodity and a second operation mode in which the customer performs operations from registration of the purchased commodity to settlement on a payment amount of the purchased commodity; and a first control module configured to control the first display device to display an image indicating contents of an error at the time the first operation mode is selected, and control the second display device to display an image for instructing to call the store clerk at the time the second operation mode is selected if the error occurs in the registration operation.

Hereinafter, an embodiment of a registration settlement apparatus is described with reference to the accompanying drawings. In the present embodiment, a POS (Point Of Sales) terminal of a POS system for a convenience store is described as the registration settlement apparatus.

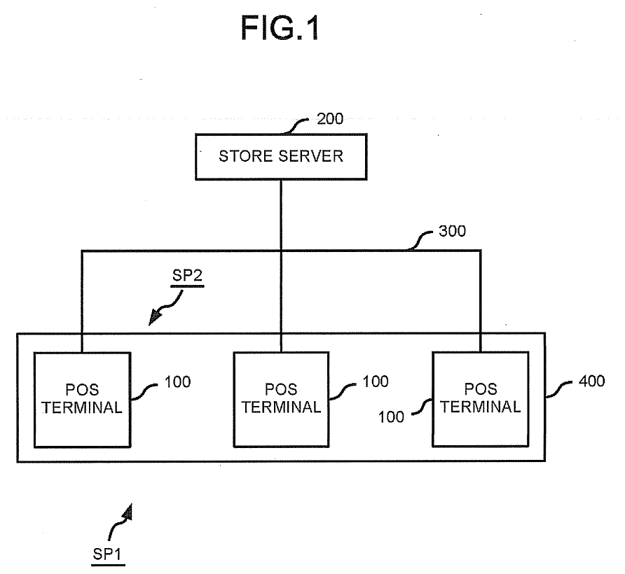

FIG. 1 is a diagram illustrating an overall configuration of a POS system. The POS system is configured by connecting a plurality of POS terminals 100 with a store server 200 via a communication network 300. The communication network 300 may be wireless or wired. The communication network 300 is typically an LAN (Local Area Network). The communication network 300 may also be the Internet, a virtual private network (VPN), a public communication network, a mobile communication network or the like, or a combination thereof as appropriate in addition to the LAN.

The POS terminals 100 are all installed on a checkout counter 400 provided in a retail store to separate a sales floor space SP1 and a workspace SP2 of the store clerk. FIG. 1 shows a state in which three POS terminals 100 are installed on the checkout counter 400. As shown in FIG. 1, the POS terminals 100 are arranged side by side at predetermined intervals along a longitudinal direction of the checkout counter 400. Each POS terminal 100 is operated by a store clerk present on the workspace SP2 side and a customer present on the sales floor space SP1 side with the checkout counter 400 therebetween.

Each POS terminal 100 has a function of registering sales data of a purchased commodity that the customer purchases and calculating payment amount for the customer based on the registered sales data, and has a function of receiving payment of the amount from the customer and performing settlement of the commercial transaction with the customer. Since such functions are known in a known POS terminal, and thus detailed description thereof is omitted.

The store server 200 is installed in a back office of the retail store. The store server 200 may be installed in a space other than the back office. The store server 200 has a function of collecting sales data of each commodity registered by each POS terminal 100 via the communication network 300, and has a function of totalizing the sales data of the purchased commodity, for example, by category, by time zone or by the person in charge based on the collected sales data. Such functions are also known in the known store server, and thus the detailed description thereof is omitted.

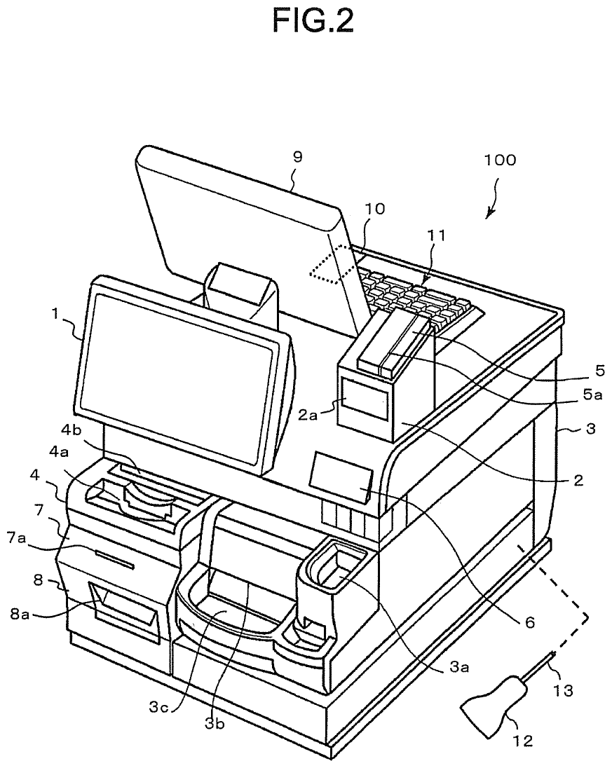

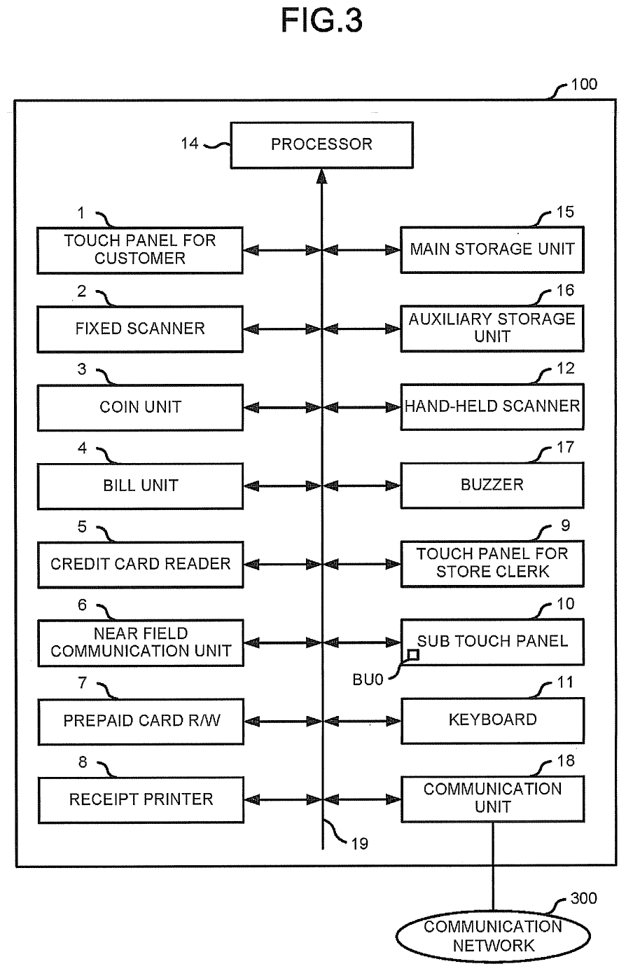

Next, the hardware configuration of the POS terminal 100 is described using the perspective view of the external appearance of the POS terminal 100 shown in FIG. 2 and the block diagram showing circuit configuration of main components of the POS terminal 100 shown in FIG. 3. The POS terminal 100 is installed on the checkout counter 400 in such a manner that the right rear side thereof in FIG. 2 faces the workspace SP2 and the left front side thereof in FIG. 2 faces the sales floor space SP1. In FIG. 2, the right rear side is a store clerk side, and the left front side is a customer side. Therefore, in the following description, the right rear side in FIG. 2 is referred to as a store clerk side, and the left front side is referred to as a customer side.

The POS terminal 100 includes a touch panel for customer 1, a fixed scanner 2, a coin unit 3, a bill unit 4, a credit card reader 5, a near field communication unit 6, a prepaid card reader/writer (prepaid card R/W) 7, a receipt printer 8, a touch panel for store clerk 9, a sub touch panel 10, a keyboard 11 and a hand-held scanner 12.

The touch panel for customer 1 is oriented towards the customer side as shown in FIG. 2. The touch panel for customer 1 displays a screen for providing information to a customer. The touch panel for customer 1 receives an instruction input through a touch operation on the screen by the customer. The touch panel for customer 1 is an example of a second display device.

The fixed scanner 2 has a reading window 2a facing the customer side. The fixed scanner 2 photographs a commodity held in front of the reading window 2a to recognize barcode information indicated by a barcode attached to the commodity by performing image processing. Then, the fixed scanner 2 outputs the recognized barcode information to a later-described processor 14. The fixed scanner 2 may be another type of known device such as a device optically reading a barcode using the reflection of a laser beam. The fixed scanner 2 may also be a known device having a function of specifying a commodity from an image of the commodity obtained by photographing the commodity through an object recognition technology.

The coin unit 3 includes a coin insertion slot 3a, a coin discharge port 3b and a coin tray 3c. The coin insertion slot 3a is formed in such a manner that coins can be inserted from the customer side. The coin unit 3 accommodates coins inserted from the coin insertion slot 3a in an internal storage while counting the coins by denomination. The coin unit 3 discharges coins accommodated in the storage to the coin tray 3c via the coin discharge port 3b. The coin tray 3c is formed in such a manner that coins can be taken out from the customer side.

The bill unit 4 includes a bill insertion slot 4a and a bill discharge port 4b. The bill insertion slot 4a is formed in such a manner that bills can be inserted from the customer side. The bill unit 4 accommodates bills inserted from the bill insertion slot 4a in an internal storage while counting the bills by denomination. The bill unit 4 discharges bills accommodated in the storage from the bill discharge port 4b. The bill discharge port 4b holds the discharged bills in a state in which a part thereof are exposed to the outside. The bill discharge port 4b is formed in such a manner that the bills held as described above can be taken out from the customer side.

The credit card reader 5 reads card information from a credit card slid along a slit 5a. The credit card reader 5 is arranged in such a manner that the slit 5a faces the customer side so that it is suitable for a customer present on the customer side to slide the credit card.

The near field communication unit 6 is provided to form a communication range on the customer side. The near field communication unit 6 carries out near filed wireless communication with a wireless tag in proximity from the customer side to acquire data stored in the wireless tag. The near field communication unit 6 writes information to the wireless tag by the near field wireless communication.

The prepaid card reader/writer 7 includes a slot 7a. The prepaid card reader/writer 7 reads card data magnetically recorded on a prepaid card inserted in the slot 7a. The prepaid card reader/writer 7 writes data to the prepaid card inserted in the slot 7a.

The receipt printer 8 prints a receipt image on a receipt paper. The receipt printer 8 discharges the receipt paper on which the receipt image is printed from a receipt discharge port 8a to the outside.

The touch panel for store clerk 9 is oriented towards the store clerk side. The touch panel for store clerk 9 displays a screen for providing information to a store clerk. The touch panel for store clerk 9 receives an instruction input through a touch operation on the screen by the store clerk. The touch panel for store clerk 9 is an example of a first display device.

The sub touch panel 10 is oriented towards the store clerk side. The sub touch panel 10 displays a screen for providing information to the store clerk. The sub touch panel 10 receives an instruction input through a touch operation on the screen by the store clerk.

The keyboard 11 includes a large number of keys arranged to be easily operated by the store clerk present in the workspace SP2 on the store clerk side. The keyboard 11 receives an instruction of the store clerk input through pressing these keys.

The hand-held scanner 12 is held by the operator to optically scan a barcode facing a reading port thereof. The hand-held scanner 12 is connected to the POS terminal 100 via a communication cable 13, and the operator can operate the hand-held scanner 12 not only from the store clerk side but also from the customer side.

In addition to the components also shown in FIG. 2, the POS terminal 100 further includes a processor 14, amain storage unit 15, an auxiliary storage unit 16, a buzzer 17, a communication unit 18 and a transmission line 19, as shown in FIG. 3. The components also shown in FIG. 2, the processor 14, the main storage unit 15, the auxiliary storage unit 16, the buzzer 17 and the communication unit 18 are connected to the transmission line 19.

The processor 14, the main storage unit 15 and the auxiliary storage unit 16 connected via the transmission line constitute a computer that executes an information processing for controlling the POS terminal 100.

The processor 14 acts as a central component of the computer. The processor 14 executes information processing programs such as application programs stored in the main storage unit 15 and the auxiliary storage unit 16 according to an operating system (OS) and middleware to control each section of the POS terminal 100 to perform various functions of the POS terminal 100.

The main storage unit 15 acts as a main memory component of the computer. The main storage unit 15 includes a nonvolatile memory area and a volatile memory area. The main storage unit stores the information processing programs in the nonvolatile memory area. The main storage unit 15 may also store data necessary for the processor 14 executing various types of information processing in the nonvolatile memory area or the volatile memory area. The main storage unit 15 uses the volatile memory area as a work area where data is appropriately rewritten by the processor 14.

The auxiliary storage unit 16 acts as an auxiliary memory component of the computer. The auxiliary storage unit 16 is, for example, an EEPROM (Electric Erasable Programmable Read-Only Memory), an HDD (Hard Disc Drive), an SSD (Solid State Drive), or the like. The auxiliary storage unit 16 stores data used by the processor 14 to perform various types of information processing and data generated in a processing performed by the processor 14. The auxiliary storage unit 16 may also store the above-described information processing program.

The communication unit 18 performs communication processing for allowing the processor 14 to transmit and receive various kinds of data to and from a device such as the store server 200 via the communication network 300. The communication unit 18 may be a known device conforming to a communication system of the communication network 300.

The buzzer 17 sounds to issue a warning sound in response to a driving signal applied from the processor 14. The buzzer 17 sounds to issue different warning sounds depending on the types of the driving signals. For example, the buzzer 17 may sound to intermittently issue warning sound repeatedly. The buzzer 17 may sound to issue warning sound continuously, for example.

The transmission line 19 includes an address bus, a data bus, a control signal line, and the like. The transmission line 19 transmits data and signals transmitted and received between the connected sections.

The hardware of an existing POS terminal may be used as the basic hardware of the POS terminal 100, for example. The POS terminal 100 is generally transferred in a state in which the information processing program for implementing the information processing described below is stored in the main storage unit 15 or the auxiliary storage unit 16. However, in a state in which the information processing program is not stored in the main storage unit 15 or the auxiliary storage unit 16, the hardware of the POS terminal 100 and the information processing program may be separately transferred. The information processing program may be written in the main storage unit 15 or the auxiliary storage unit 16 in response to an operation by an administrator of the POS terminal 100 or the like. The information processing program may be transferred by recording it on a removable recording medium such as a magnetic disk, a magneto-optical disk, an optical disk, a semiconductor memory, etc., or through communication via the network.

The POS terminal 100 having such a configuration can be properly used in two ways: a so-called semi-self-service operation in which the store clerk performs registration and the customer performs settlement operation on the payment amount, and a so-called full-self-service operation in which the customer performs operations from registration to settlement. Specifically, in the POS terminal 100, the touch panel for store clerk 9, the sub touch panel 10 and the keyboard 11 are oriented towards the store clerk side. In the POS terminal 100, the touch panel for customer 1, the reading window 2a of the fixed scanner 2, the coin insertion slot 3a and the coin discharge port 3b of the coin unit 3, the bill insertion slot 4a and the bill discharge port 4b of the bill unit 4, the slit 5a of the credit card reader 5, the near field communication unit 6, the slot 7a of the prepaid card reader/writer 7 and the receipt discharge port 8a of the receipt printer 8 are oriented towards the customer side. The hand-held scanner 12 is placed at a position where not only the store clerk present in the workspace SP2 on the store clerk side but also the customer present in the sales floor space SP1 on the customer side can use it.

Therefore, in the case of the semi-self-service operation, the store clerk present in the workspace SP2 can appropriately use the touch panel for store clerk 9, the sub touch panel 10, the keyboard 11 and the hand-held scanner 12 to register the commodity that the customer purchases. On the other hand, in the case of the full-self-service operation, the customer present in the sales floor space SP1 can appropriately use the touch panel for customer 1, the fixed scanner 2 and the hand-held scanner 12 to register the commodity that he/she purchases. In the semi-self-service operation or the full-self-service operation, the customer present in the sales floor space SP1 can appropriately use the touch panel for customer 1, the coin unit 3, the bill unit 4, the credit card reader 5, the near field communication unit 6 and the prepaid card reader/writer 7 to perform settlement operation on the payment amount of the purchased commodity. Since the receipt printed by the receipt printer 8 is discharged from the receipt discharge port 8a, the customer present in the sales floor space SP1 can receive the receipt not through the store clerk.

In order to enable the POS terminal 100 to be properly used in the semi-self-service operation and the full-self-service operation, an operation mode of the POS terminal 100 includes a first operation mode corresponding to the semi-self-service operation and a second operation mode corresponding to the full-self-service operation. Therefore, in the following description, the first operation mode is referred to as a semi-self-service mode, and the second operation mode is referred to as a full-self-service mode.

The POS terminal 100 stores a mode flag MF for identifying the operation mode in the main storage unit 15 or the auxiliary storage unit 16. The processor 14 of the POS terminal 100 operates in the semi-self-service mode when “0” is set in the mode flag MF, and operates in the full-self-service mode when “1” is set in the mode flag MF. In this regard, the processor 14 may operate in the full-self-service mode when “0” is set in the mode flag MF, and operate in the semi-self-service mode when “1” is set in the mode flag MF.

In the POS terminal 100, a mode switching button BUO is arranged on a part of a keyboard screen displayed on the sub touch panel 10 as shown in FIG. 3. The mode switching button BUO functions as an instruction module for the operator to instruct switching between the semi-self-service mode and the full-self-service mode. Since the sub touch panel 10 is oriented towards the store clerk side, the operator is a store clerk present in the workspace SP2. The instruction module is not limited to the mode switching button BU0. The instruction module may be, for example, a button arranged on a part of a screen displayed on the touch panel for store clerk. The instruction module maybe a key arranged on the keyboard 11. The instruction module may be other modules.

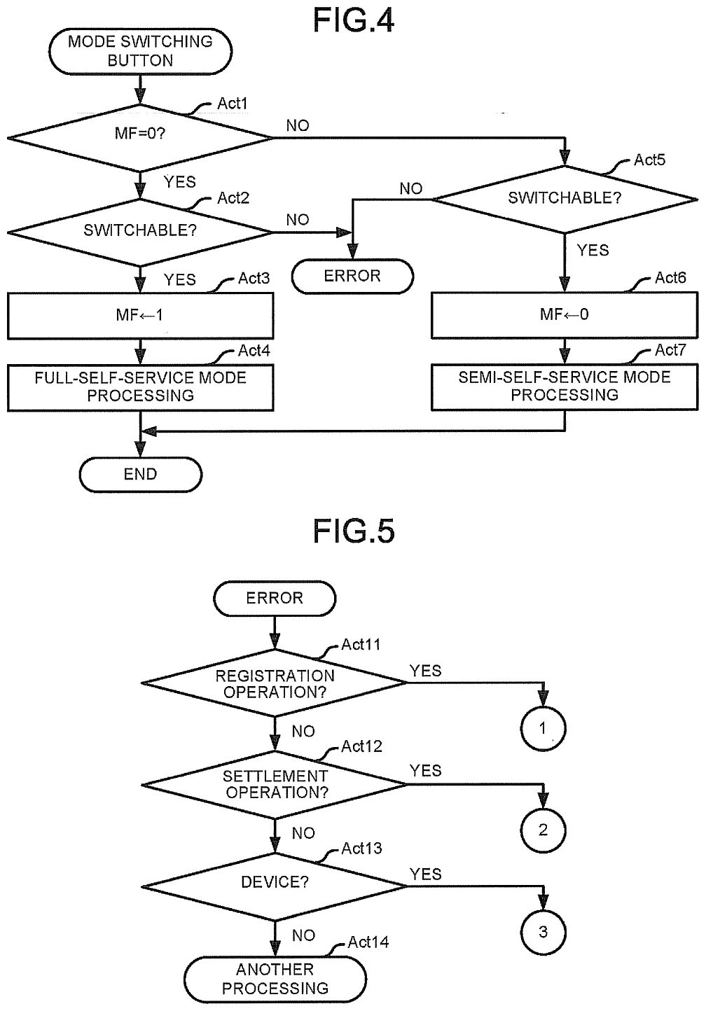

FIG. 4 is a flowchart depicting procedures of a processing executed by the processor 14 in response to an operation on the mode switching button BU0. The processing procedure is executed based on the information processing program stored in the main storage unit 15 or the auxiliary storage unit 16. The contents of the processing shown in FIG. 4 and described below are merely an example. The processing procedure and the contents of the processing are not particularly limited as long as the same results can be achieved.

If the mode switching button BU0 is operated, the processor 14 checks the mode flag MF in Act 1. If “0” is set in the mode flag MF, the processor 14 takes Yes in Act 1 and proceeds to the processing in Act 2. The processor 14 determines whether or not the switching from the semi-self-service mode to the full-self-service mode is enabled in Act 2.

The switching from the semi-self-service mode to the full-self-service mode is enabled at the time the POS terminal 100 is in a login state in which a person in charge is registered and in a state in which no commodity data is input. However, it is prohibited to enable all the POS terminals 100 in operation to operate in the full-self-service mode in terms of practical use. The person in charge login state is a state in which the store clerk who actually operates the POS terminal 100 performs a sign-in at the time of starting the operation. When the store clerk performs the sign-in operation, a unique ID number of the store clerk is registered as a person in charge number in a person in charge memory. The person in charge memory is arranged in the main storage unit 15. The person in charge login state is a state in which the ID number of one of the store clerks is registered in the person in charge memory. The no commodity data input state is a state in which the registration of the purchased commodity is not performed. For example, when the commodity code is scanned by the hand-held scanner 12, the sales data of the commodity identified by the commodity code is registered in a transaction memory. The transaction memory is arranged in the main storage unit 15. The no commodity data input state refers to a state in which the sales data is not yet registered in the transaction memory.

The processor 14 checks the mode flag MF of the other POS terminals 100 connected via the communication network 300 when both the person in charge login state and the no commodity data input state are satisfied. If it is confirmed that “0” indicating the semi-self-service mode is set in the mode flag MF of at least one POS terminal 100 among the other POS terminals 100, the processor 14 takes Yes in Act 2 and proceeds to the processing in Act 3. The processor 14 changes the mode flag MF to “1” in Act 3. Subsequently, the processor 14 executes a full-self-service mode processing in Act 4.

The full-self-service mode processing includes the following processing. Specifically, the processor 14 disables the input from the touch panel for store clerk 9 and the keyboard 11. The processor 14 records information indicating that the mode is switched from the semi-self-service mode to the full-self-service mode in an electronic journal file, together with information relating to the person in charge who performs the sign-in. The electronic journal file is stored in the auxiliary storage unit 16. The processor 14 enables a part of a screen on the touch panel for store clerk 9 to display an image indicating that the POS terminal 100 is in the full-self-service mode. The processor 14 registers a fixed ID number not assigned to store clerks, for example, “999” in the person in charge number memory as a person in charge number in the full-self-service mode. The full-self-service mode processing is not limited to the above processing.

On the other hand, if “1” is set in the mode flag MF, the processor 14 takes No in Act 1 and proceeds to the processing in Act 5. The processor 14 determines whether or not the switching from the full-self-service mode to the semi-self-service mode is enabled in Act 5.

The switching from the full-self-service mode to the semi-self-service mode is enabled in an initial state after the termination of settlement. If the receipt is issued and the settlement is terminated, the screen on the touch panel for customer 1 becomes an initial screen. The contents of the initial screen are not limited. For example, the initial screen may be a screen showing an advertisement. The initial state after the termination of settlement is a state in which the initial screen is displayed on the touch panel for customer 1.

If the initial state after the termination of settlement is entered, the processor 14 takes Yes in Act 5 and proceeds to the processing in Act 6. The processor 14 changes the mode flag MF to “0” in Act 6. Subsequently, the processor 14 executes a semi-self-service mode processing in Act 7.

The semi-self-service mode processing includes the following processing. Specifically, the processor 14 enables the touch panel for store clerk 9 to display a pop-up image for input of the person in charge number. The processor 14 records information indicating that the mode is switched from the full-self-service mode to the semi-self-service mode in the electronic journal file. The processor 14 displays an image indicating that the POS terminal 100 is in the semi-self-service mode on a part of the screen on the touch panel for store clerk 9.

After the full-self-service mode processing or the semi-self-service mode processing is terminated, the processor 14 terminates an input processing of the mode switching button BU0. If a switching condition from the semi-self-service mode to the full-self-service mode is not satisfied in Act 2 or a switching condition from the full-self-service mode to the semi-self-service mode is not satisfied in Act 5, the processor 14 notifies an error of the input processing.

The computer of the POS terminal 100 with the processor 14 as the central component functions as a switching module that switches the mode between the semi-self-service mode and the full-self-service mode by executing the processing in Act 1 to Act 7 in FIG. 4.

FIG. 5 to FIG. 8 are flowcharts depicting procedures of an error processing executed by the processor 14. The processing procedure is executed according to the information processing program stored in the main storage unit 15 or the auxiliary storage unit 16. The contents of the processing shown in FIG. 5 to FIG. 8 and described below merely are an example. The processing procedure and contents of the processing are not particularly limited as long as the same results can be achieved.

The processor 14 starts the processing procedure shown in the flowchart in FIG. 4 when an error occurs while various kinds of information processing are executed. First, in Act 11, the processor 14 determines whether or not the error occurs in the process of the information processing by the registration operation of commodity sales data, i.e., a registration operation error. If the error is not the registration operation error, the processor 14 takes No in Act 11 and proceeds to the processing in Act 12.

The processor 14 determines whether or not the error occurs in the process of the information processing by the settlement operation on the payment amount, i.e., a settlement operation error in Act 12. If the error is not the settlement operation error, the processor 14 takes No in Act 12 and proceeds to the processing in Act 13.

In Act 13, the processor 14 determines whether or not the error is caused by malfunction of the device, i.e., a device error. If the error is not the device error, the processor 14 takes No in Act 13 and proceeds to the processing in Act 14.

The processor 14 executes another processing in Act 14. Another processing is a processing for an error other than the registration operation error, the settlement operation error and the device error. For example, another processing may be a processing for an error occurring in an input processing of the mode switching button BUO described above. At this time, the processor 14 performs, for example, a processing of displaying a message such as “mode cannot be changed” on the touch panel for store clerk 9 as another processing.

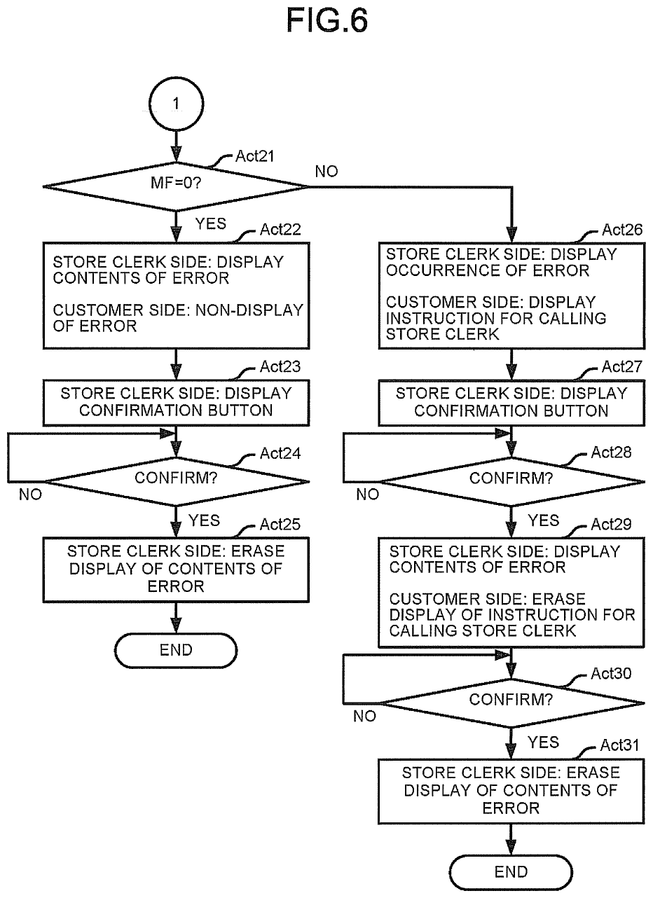

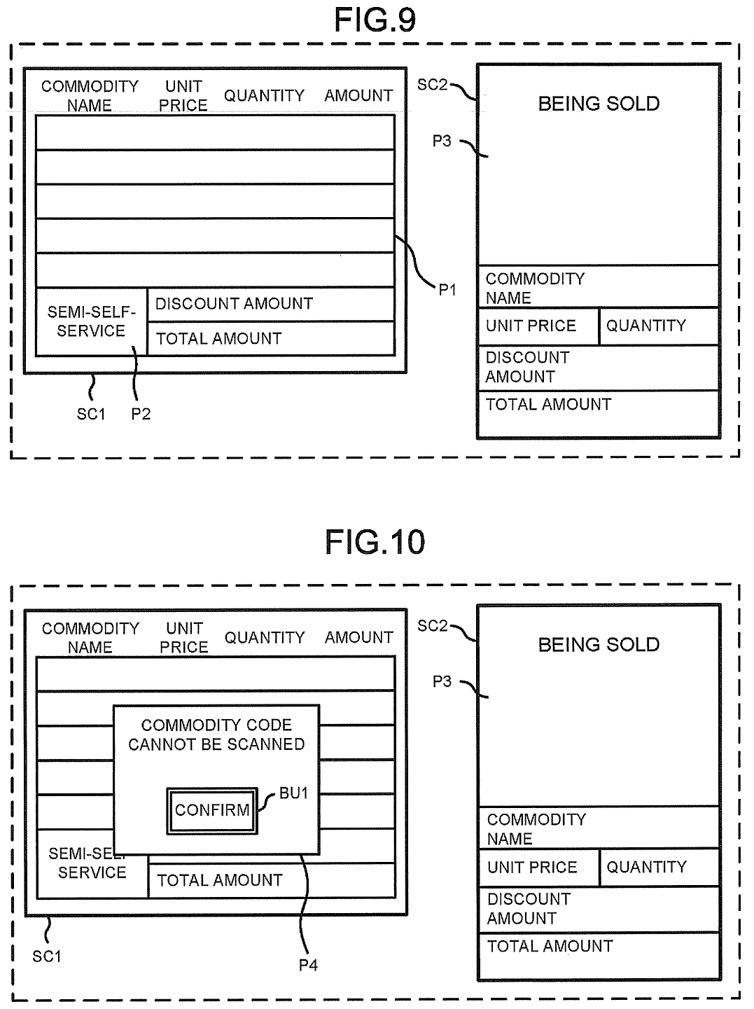

Next, the operation of the POS terminal 100 when the registration operation error occurs is described with reference to the flowchart in FIG. 6 and screen displays in FIG. 9 to FIG. 13.

If the error is the registration operation error, the processor 14 takes Yes in Act 11 in FIG. 5 and proceeds to the processing in Act 21 in FIG. 6. The processor 14 checks the mode flag MF in Act 21.

If the registration operation error occurs at the time “0” is set in the mode flag MF, i.e., the POS terminal 100 is in the semi-self-service mode, the processor 14 takes Yes in Act 21 and proceeds to the processing in Act 22. The processor 14 controls the touch panel for store clerk 9 to display an image indicating contents of the error in Act 22. At this time, the processor 14 controls the touch panel for customer 1 not to display a content relating to an error. The processor 14 arranges a confirmation button BU1 on a part of the screen on the touch panel for store clerk 9 in Act 23.

FIG. 9 shows a screen SC1 on the touch panel for store clerk 9 and a screen SC2 on the touch panel for customer 1 at the time of the registration operation in the POS terminal 100 operating in the semi-self-service mode. As shown in FIG. 9, the screen SC1 on the touch panel for store clerk 9 displays a purchased commodity list P1. In the purchased commodity list P1, a commodity name, unit price, quantity, amount, a discount amount, and a total amount of the purchased commodity registered in one transaction are displayed. The screen SC1 also displays an image P2 indicating that the POS terminal 100 is in the semi-self-service mode. The screen SC2 on the touch panel for customer 1 displays a commodity name, unit price, and quantity of a most recently registered commodity, and a discount amount and a total amount of one transaction. An advertisement image P3 may also be displayed on the screen SC2.

While the POS terminal 100 operates in the semi-self-service mode, the store clerk operates, for example, the hand-held scanner 12 to scan the barcode attached to the purchased commodity. Then, in the POS terminal 100, the sales data of the commodity identified by the commodity code read from the barcode is registered in the transaction memory. Then, the commodity name, the unit price, the quantity and the amount of the commodity are added to the purchased commodity list P1. The commodity name, the unit price and the quantity of the commodity are displayed on the screen SC2 on the touch panel for store clerk 1.

However, there is a case in which an error occurs in reading of the commodity code, for example, because the barcode is stained or dust is stuck to the barcode. In such a case, the processor 14 recognizes that the registration operation error occurs. Thus, the processor 14 executes the processing in Act 22 and Act 23. As a result, as shown in FIG. 10, on the screen SC1 on the touch panel for store clerk 9, an image P4 indicating contents of the error and the confirmation button BU1 are displayed. The screen SC2 on the touch panel for customer 1 does not change.

Therefore, the store clerk present in the workspace SP1 can know from the image P4 displayed on the screen SC1 on the touch panel for store clerk 9 that the reading error of the commodity code occurs. In this case, the store clerk may touch the confirmation button BU1, and then, for example, operate the keyboard 11 to manually input the commodity code. By doing this, the registration operation error can be solved or released. At this time, since the screen SC2 on the touch panel for customer 1 does not change, the customer does not need to take any action for the registration operation error. Therefore, the store clerk can perform an error handling work efficiently for the registration operation error in the semi-self-service mode.

Returning to the description in FIG. 6.

The processor 14 terminating the processing in Act 22 and Act 23 waits for the touch operation on the confirmation button BU1 in Act 24. If the processor 14 detects that the confirmation button BU1 is touched according to the input from the touch panel for store clerk 9, the processor 14 takes Yes in Act 24 and proceeds to the processing in Act 25. The processor 14 erases the image P4 and the confirmation button BU1 displayed on the screen SC1 on the touch panel for store clerk 9 in Act 25. The processor 14 terminates the information processing for the registration operation error while the POS terminal 100 operates in the semi-self-service mode.

On the other hand, if the registration operation error occurs at the time “1” is set in the mode flag MF, i.e., the POS terminal 100 is in the full-self-service mode, the processor 14 takes No in Act 21 and proceeds to the processing in Act 26. The processor 14 controls the touch panel for store clerk 9 to display an image having contents for notifying occurrence of the error. The processor 14 controls, on the other hand, the touch panel for customer 1 to display an image having contents for instructing to call a store clerk. Furthermore, the processor 14 arranges the confirmation button BU1 on a part of the screen on the touch panel for store clerk 9 in Act 27.

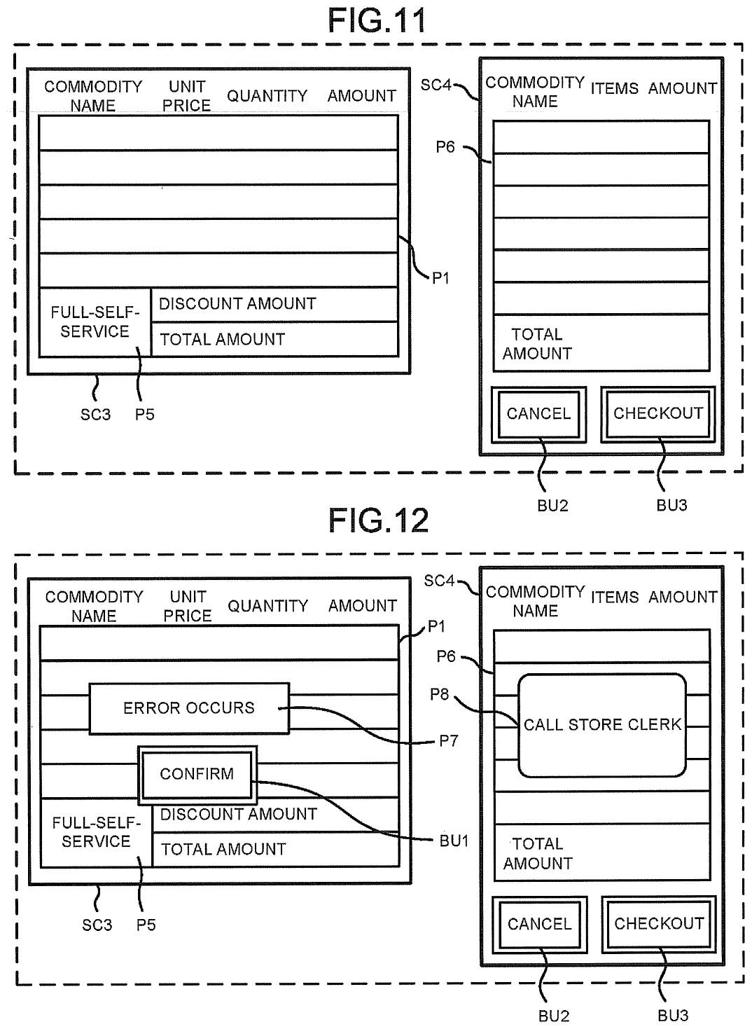

FIG. 11 shows a screen SC3 on the touch panel for store clerk 9 and a screen SC4 on the touch panel for customer 1 at the time of the registration operation in the POS terminal 100 operating in the full-self-service mode. As shown in FIG. 11, the screen SC3 on the touch panel for store clerk 9 displays the purchased commodity list P1 the same as that displayed in the case of operating in the semi-self-service mode. The screen SC3 also displays an image P5 indicating that the POS terminal 100 is operating in the full-self-service mode. A purchased commodity list P6 is displayed on the screen SC4 on the touch panel for customer 1. The purchased commodity list P6 includes the commodity name, the quantity, the amount and the total amount of the purchased commodity registered in one transaction. A cancel button BU2 and a checkout button BU3 are arranged on the screen SC4. The cancel button BU2 is touched when the customer cancels the registration of the purchased commodity. The checkout button BU3 is touched when the customer finishes registration of the purchased commodity and shifts to settlement operation on the payment amount.

While the POS terminal 100 is operating in the full-self-service mode, a customer present in the sales floor space SP1 holds, for example, the barcode attached to the purchased commodity over the fixed scanner 2. Alternatively, the customer uses the hand-held scanner 12 to scan the barcode attached to the purchased commodity. Then, in the POS terminal 100, the sales data of the commodity identified by the commodity code read from the barcode is registered in the transaction memory. Then, the commodity name, the quantity and the amount of the commodity are added to the purchased commodity list P6. The commodity name, the unit price, the quantity and the amount of the commodity are also added to the purchased commodity list P1.

However, among the commodities sold in the store, there are commodities that cannot be sold in the full-self-service mode. For example, the customer cannot purchase a commodity, such as alcohol or cigarette, which requires age verification, without the assistance of the store clerk. The same condition is also applied to medicines belonging to the first class OTC or second class OTC medicine. If the barcode attached to the purchased commodity with such sales restriction is scanned by the fixed scanner 2 or the hand-held scanner 12, the processor 14 checks the mode flag MF. When “1” is set in the mode flag, i.e., the POS terminal 100 is operating in the full-self-service mode, the processor 14 recognizes the reading of the barcode as the registration operation error. In other words, the processor 14 executes the processing in Act 26 and Act 27. As a result, as shown in FIG. 12, on the screen SC3 on the touch panel for store clerk 9, an image P7 showing contents indicating the occurrence of the error and the confirmation button BU1 are displayed. On the screen SC4 on the touch panel for customer 1, an image P8 having contents for instructing to call the store clerk is displayed.

Therefore, the customer calls the store clerk according to the contents of the image P8. Generally, the store clerk is not present in front of the POS terminal 100 operating in the full-self-service mode. However, since at least one POS terminal 100 is operating in the semi-self-service mode, at least one store clerk is present in the workspace SP2. The store clerk called by the customer moves in the workspace SP2. When the store clerk confirms the image P7 displayed on the touch panel for store clerk 9, he/she touches the confirmation button BU1 displayed together with the image P7 on the touch panel for store clerk 9.

Returning to the description in FIG. 6.

The processor 14 terminating the processing in Act 26 and Act 27 waits for a touch operation on the confirmation button BU1 in Act 28. If the processor 14 detects that the confirmation button BU1 is touched according to the input from the touch panel for store clerk 9, the processor 14 takes Yes in Act 28 and proceeds to the processing in Act 29. The processor 14 erases the image P7 displayed on the touch panel for store clerk 9 in Act 29 and instead, displays an image indicating the contents of the error. The processor 14 erases the image P8 displayed on the touch panel for customer 1.

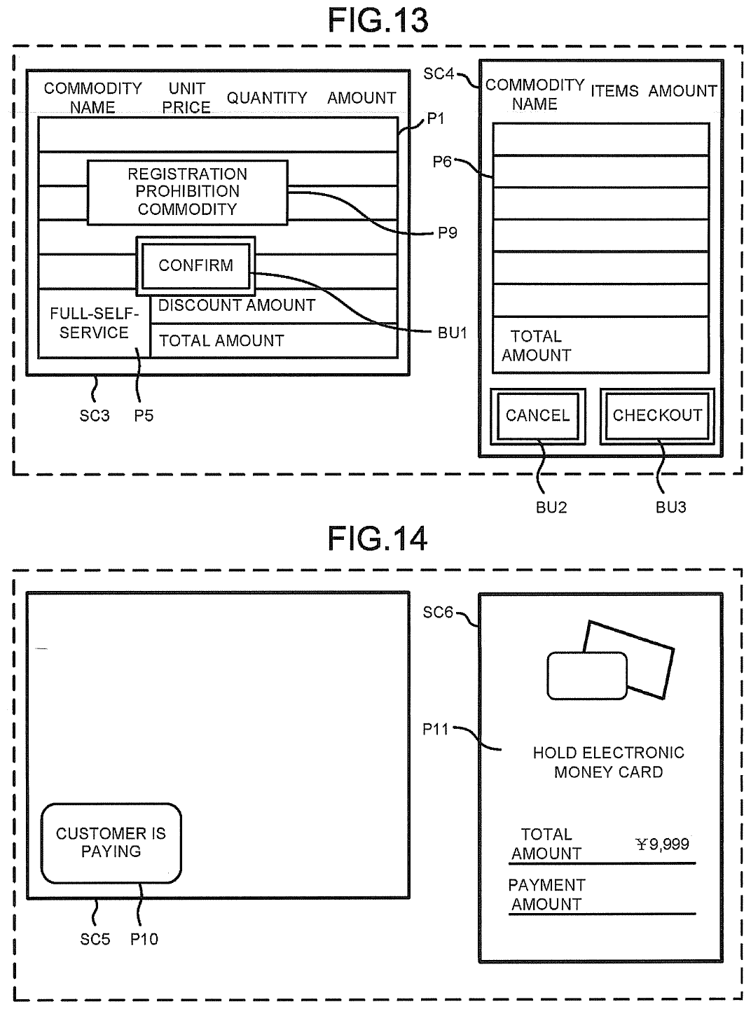

FIG. 13 shows the screen SC3 on the touch panel for store clerk 9 and the screen SC4 on the touch panel for customer 1 after the confirmation button BU1 is touched in the state shown in FIG. 12. As shown in FIG. 13, on the screen SC3 on the touch panel for store clerk 9, an image P9 indicating the contents of an error is displayed instead of the image P7. The image P8 is erased from the screen SC4 on the touch panel for customer 1.

Therefore, the store clerk present in the workspace SP1 can know the state of the POS terminal 100 from the image P9 displayed on the screen SC3 on the touch panel for store clerk 9 that the registration operation error occurs due to reading of a code attached to the commodity that cannot be sold in the full-self-service mode. In this case, the store clerk touches the confirmation button BU1. Then, the store clerk, for example, touches a button provided on the sub touch panel 10 to perform an operation for permitting registration of the registration prohibition commodity only once, and then operates the hand-held scanner 12 to scan the barcode attached to the commodity which causes a registration error. Then, in the POS terminal 100, the sales data of the commodity is registered in the transaction memory. The operation for permitting registration of the registration prohibition commodity is not limited to the touch operation on a button provided on the sub touch panel 10. For example, if each store clerk has an ID card indicating an ID number of the store clerk with a barcode, the store clerk may permit registration of the registration prohibition commodity only once by scanning the barcode on the ID card, using the hand-held scanner 12.

Thus, when the registration operation error occurs in the POS terminal 100 operating in the full-self-service mode, the customer calls a store clerk according to the contents of the image P8 displayed on the touch panel for customer 1. On the other hand, the store clerk can rapidly move to the installation location of the POS terminal 100 in which the registration operation error occurs in response to the call for store clerk from the customer. In addition, the store clerk can accurately grasp the contents of the error from the image P9 displayed on the screen SC3 on the touch panel for store clerk 9. Therefore, even in the full-self-service mode, the customer and the store clerk can perform the error handling work efficiently for the registration operation error.

Returning to the description in FIG. 6.

After the processing in Act 29 is terminated, the processor 14 waits for a touch operation on the confirmation button BU1 in Act 30. If the processor 14 detects that the confirmation button BU1 is touched according to the input from the touch panel for store clerk 9, the processor 14 takes Yes in Act 30 and proceeds to the processing in Act 31. The processor 14 erases the image P9 and the confirmation button BU1 displayed on the screen SC3 on the touch panel for store clerk 9 in Act 31. The processor 14 terminates the information processing for the registration operation error in the full-self-service mode operation.

The computer of the POS terminal 100 with the processor 14 as the central component functions as a first control module by executing the processing in Act 21, Act 22 and Act 26 in FIG. 6.

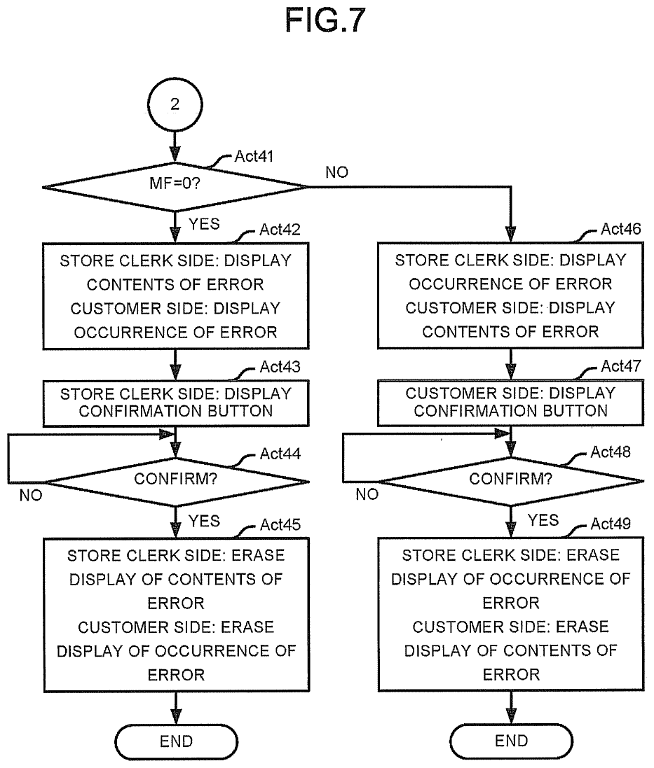

Next, the operation of the POS terminal 100 when the settlement operation error occurs is described referring to the flowchart in FIG. 7 and the screen displays in FIG. 14 to FIG. 17.

If the error is the settlement operation error, the processor 14 takes Yes in Act 12 in FIG. 5, and proceeds to the processing in Act 41 in FIG. 7. The processor 14 checks the mode flag MF in Act 41.

If the settlement operation error occurs at the time “0” is set in the mode flag MF, i.e., the POS terminal 100 is operating in the semi-self-service mode, the processor 14 takes Yes in Act 41 and proceeds to the processing in Act 42. The processor 14 controls the touch panel for store clerk 9 to display an image indicating contents of the error in Act 42. The processor 14 controls the touch panel for customer 1 to display an image for notifying occurrence of the error. Furthermore, the processor 14 arranges the confirmation button BU1 on a part of the screen on the touch panel for store clerk 9 in Act 43.

FIG. 14 shows a screen SC5 on the touch panel for store clerk 9 and a screen SC6 on the touch panel for customer 1 when the electronic money is selected as the settlement method in the POS terminal 100 operating in the semi-self-service mode. When registration of the purchased commodity is completed and the store clerk presses a closing key, for example, a customer layer key arranged on the keyboard 11, a settlement method selection screen is displayed on the touch panel for customer 1. The settlement method selection screen instructs a selection of one of the settlement methods such as cash, credit card, prepaid card, electronic money, etc. For example, a cash button, a credit card button, a prepaid card button, an electronic money button, etc. are displayed on the settlement method selection screen. Then, the customer confirming the settlement method selection screen touches one of the buttons to which the settlement method he/she desires to choose is assigned. FIG. 14 shows the screen SC5 on the touch panel for store clerk 9 and the screen SC6 on the touch panel for customer 1 after the electronic money button is touched.

As shown in FIG. 14, on the screen SC5 on the touch panel for store clerk 9, an image P10 having contents indicating that the customer is paying is displayed. On the screen SC6 on the touch panel for customer 1, an image P11 having contents indicating operation guidance for the selected settlement method is displayed together with the total amount. Therefore, the customer performs settlement operation on the payment amount according to the image P11. Specifically, in the case of FIG. 14, the customer holds the electronic money card over the near field communication unit 6. At this time, for example, when a balance of the electronic money is equal to or more than the total amount and thus the settlement can be performed, the processor 14 executes a settlement processing with the electronic money.

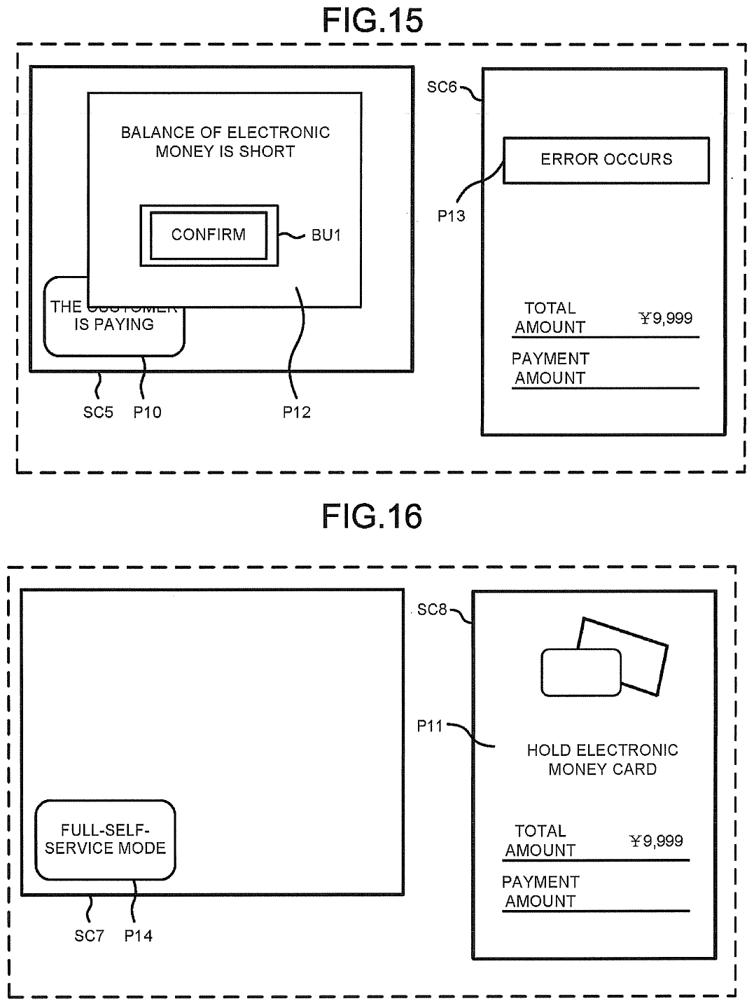

However, if the balance of the electronic money is less than the total amount, a balance shortage error occurs. In such a case, the processor 14 recognizes the error as the settlement operation error. Thus, the processor 14 executes the processing in Act 42 and Act 43. As a result, as shown in FIG. 15, on the screen SC5 on the touch panel for store clerk 9, an image P12 indicating contents of the error and the confirmation button BU1 are displayed. On the screen SC6 on the touch panel for customer 1, an image P13 having contents indicating that the error occurs is displayed.

Therefore, the store clerk can know that the balance shortage error has occurred for the electronic money from the image P12 displayed on the screen SC5 on the touch panel for store clerk 9. The customer who holds the electronic money card over the near field communication unit 6 can know that an error occurs in the settlement operation. In this case, after touching the confirmation button BU1, the store clerk instructs the customer to pay a shortage amount by another settlement method, for example, by cash. Since the customer also becomes aware of occurrence of the error in the settlement method from the image P13 displayed on the screen SC6 on the touch panel for customer 1, the customer pays the shortage amount by another settlement method according to the instruction from the store clerk. In this case, the settlement by electronic money may be stopped and the total amount is paid by another settlement method. Therefore, the store clerk and the customer can efficiently carry out the error handling work for the electronic money balance shortage error in the semi-self-service mode.

Returning to the description in FIG. 7.

The processor 14 terminating the processing in Act 42 and Act 43 waits for the touch operation on the confirmation button BU1 in Act 44. If the processor 14 detects that the confirmation button BU1 is touched according to the input from the touch panel for store clerk 9, the processor 14 takes Yes in Act 44 and proceeds to the processing in Act 45. The processor 14 erases the image P12 and the confirmation button BU1 displayed on the screen SC5 on the touch panel for store clerk 9, and the image P13 displayed on the touch panel for customer 1 in Act 45. Thus, the processor 14 terminates the information processing for the settlement operation error while the POS terminal 100 is operating in the semi-self-service mode.

On the other hand, if the settlement operation error occurs at the time “1” is set in the mode flag MF, i.e., the POS terminal 100 is operating in the full-self-service mode, the processor 14 takes No in Act 41 and proceeds to the processing in Act 46. The processor 14 controls the touch panel for store clerk 9 to display an image indicating the occurrence of the error in Act 46. The processor 14 controls the touch panel for customer 1 to display an image indicating contents of the error. Furthermore, the processor 14 arranges the confirmation button BU1 on a part of the screen on the touch panel for customer 1 in Act 47.

FIG. 16 shows a screen SC7 on the touch panel for store clerk 9 and a screen SC8 on the touch panel for customer 1 when the electronic money is selected as the settlement method in the POS terminal 100 operating in the full-self-service mode. When the customer finishes registration of the purchased commodity operated by himself/herself and touches the checkout button BU3 shown in FIG. 13, the above-described settlement method selection screen is displayed on the touch panel for customer 1. Then, the customer confirming the settlement method selection screen touches one of the buttons to which the settlement method that he/she desires to choose is assigned. FIG. 16 shows the screen SC7 on the touch panel for store clerk 9 and the screen SC8 on the touch panel for customer 1 after the electronic money button is touched.

As shown in FIG. 16, on the screen SC7 on the touch panel for store clerk 9, an image P14 having contents indicating that the POS terminal 100 is operating in the full-self-service mode is displayed. On the screen SC8 on the touch panel for customer 1, similarly to the case of the semi-self-service mode, an image P11 having contents indicating operation guidance for the selected settlement method is displayed together with the total amount. Therefore, the customer performs the settlement operation on the payment amount according to the image P11. Specifically, also in the case of FIG. 16, the customer holds the electronic money card over the near field communication unit 6. At this time, for example, when the balance of the electronic money is equal to or more than the total amount and the settlement can be performed, the processor 14 executes the settlement processing with the electronic money.

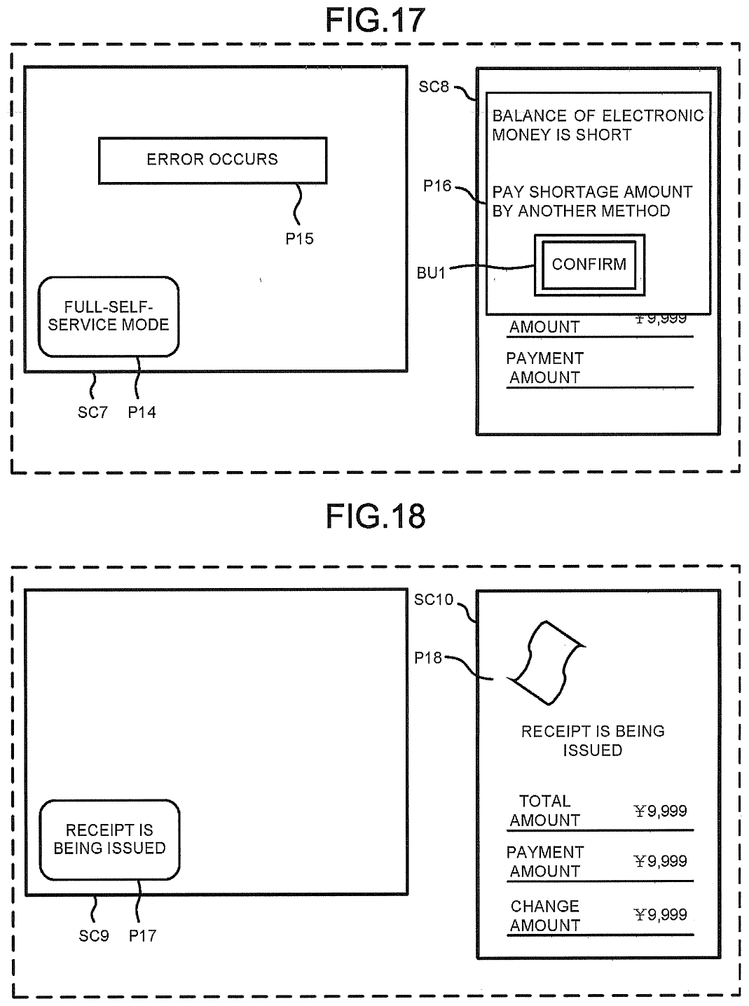

However, if the balance of the electronic money is less than the total amount, a balance shortage error occurs. In such a case, the processor 14 recognizes the error as the settlement operation error. Thus, the processor 14 executes the processing in Act 46 and Act 47. As a result, as shown in FIG. 17, on the screen SC7 on the touch panel for store clerk 9, an image P15 having contents indicating the occurrence of the error is displayed. On the screen SC8 on the touch panel for customer 1, an image P16 indicating contents of the error and the confirmation button BU1 are displayed.

Therefore, the customer becomes aware of shortage of the balance of the electronic money from the image P16 displayed on the touch panel for customer 1. In this case, after the customer touches the confirmation button BU1, for example, the customer can insert cash an amount of which is equal to the shortage amount in the bill insertion slot 4a and/or the coin insertion slot 3a. Furthermore, the settlement by electronic money may be stopped and the total amount is paid by another settlement method.

Therefore, the customer who holds the electronic money card over the near field communication unit 6 can know that the balance shortage error occurs from the image P16 displayed on the screen SC8 on the touch panel for customer 1. In this case, the customer pays the shortage amount by another settlement method. On the other hand, the store clerk present in the workspace SP2 can confirm from a distance that the error occurs from the image P15 displayed on the screen SC7 on the touch panel for store clerk 9. Therefore, if the customer is confused about the error, the store clerk can move towards the customer and give appropriate advices. Therefore, even if the POS terminal 100 is operating in the full-self-service mode, the store clerk and the customer can efficiently perform the error handling work for the electronic money balance shortage error.

Returning to the description in FIG. 7.

After terminating the processing in Act 47, the processor 14 waits for the touch operation on the confirmation button BU1 in Act 48. If the processor 14 detects that the confirmation button BU1 is touched according to the input from the touch panel for customer 1, the processor 14 takes Yes in Act 48 and proceeds to the processing in Act 49. The processor 14 erases the image P15 displayed on the screen SC7 on the touch panel for store clerk 9, and the image P16 and the confirmation button BU1 displayed on the screen SC8 on the touch panel for customer 1 in Act 49. The processor 14 terminates the information processing for the settlement operation error while the POS terminal 100 is operating in the full-self-service mode.

The computer of the POS terminal 100 with the processor 14 as the central component functions as a second control module by executing the processing in Act 41, Act 42 and Act 46 in FIG. 7.

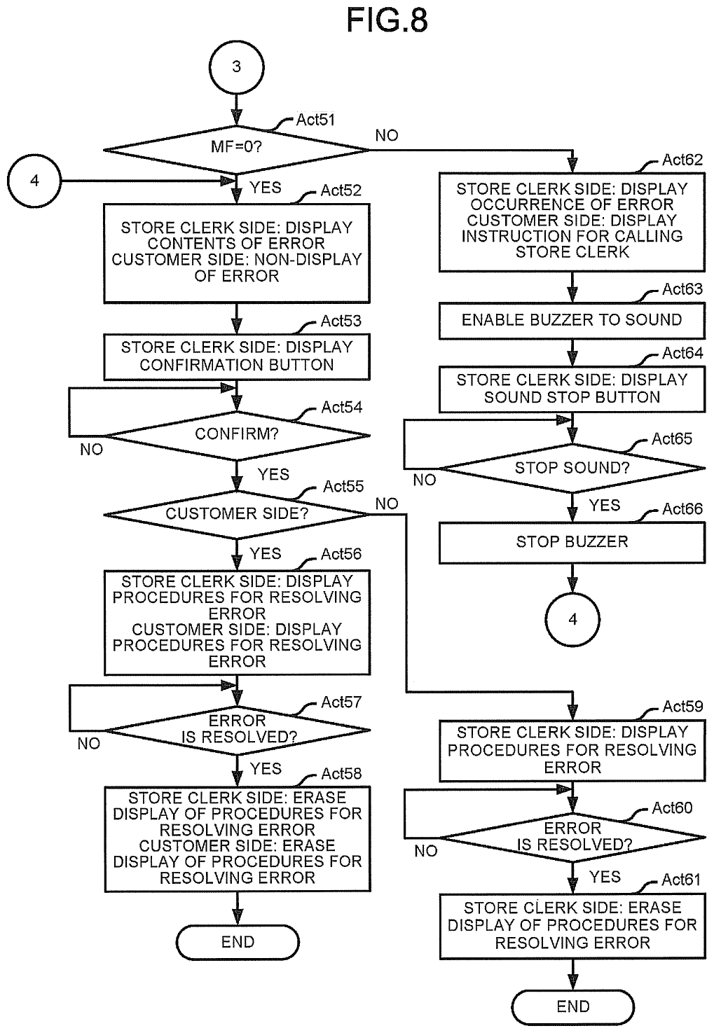

Next, the operation of the POS terminal 100 when the device error occurs is described referring to the flowchart in FIG. 8 and the screen displays in FIG. 18 to FIG. 22.

In the case of the POS terminal 100, the device thereof includes the touch panel for customer 1, the fixed scanner 2, the coin unit 3, the bill unit 4, the credit card reader 5, the near field communication unit 6, the prepaid card reader/writer 7, the receipt printer 8, the touch panel for store clerk 9, the sub touch panel 10, the keyboard 11 and the like. Among these devices, the touch panel for customer 1, the fixed scanner 2, the touch panel for store clerk 9, the sub touch panel 10 and the keyboard 11 are mainly driven in response to the registration operation. The coin unit 3, the bill unit 4, the credit card reader 5, the near field communication unit 6, the prepaid card reader/writer 7 and the receipt printer 8 are mainly driven in response to the settlement operation on the payment amount.

A case in which an error occurs in the receipt printer 8 is described. If an error occurs in another device, the processing is also performed with the same procedures and thus the description thereof is omitted.

If the error is a device error, the processor 14 takes Yes in Act 13 in FIG. 5, and proceeds to the processing in Act 51 in FIG. 8. The processor 14 checks the mode flag MF in Act 51.

If the device error occurs at the time “0” is set in the mode flag MF, i.e., the POS terminal 100 is operating in the semi-self-service mode, the processor 14 takes Yes in Act 51 and proceeds to the processing in Act 52. The processor 14 controls the touch panel for store clerk 9 to display an image indicating contents of the error in Act 52. The processor 14 does not display the error on the touch panel for customer 1. The processor 14 arranges the confirmation button BU1 on apart of the screen on the touch panel for store clerk 9 in Act 53.

FIG. 18 shows a screen SC9 on the touch panel for store clerk 9 and a screen SC10 on the touch panel for customer 1 when the receipt printer 8 operates to perform a receipt printing as a part of the settlement processing in the POS terminal 100 operating in the semi-self-service mode. As shown in FIG. 18, on the screen SC9 on the touch panel for store clerk 9, an image P17 having contents for notifying the store clerk that a receipt is being issued is displayed. On the screen SC10 on the touch panel for customer 1, an image P18 having contents for notifying the customer that the receipt is being issued in addition to the total amount, the payment amount and the change amount relating to one transaction is displayed.

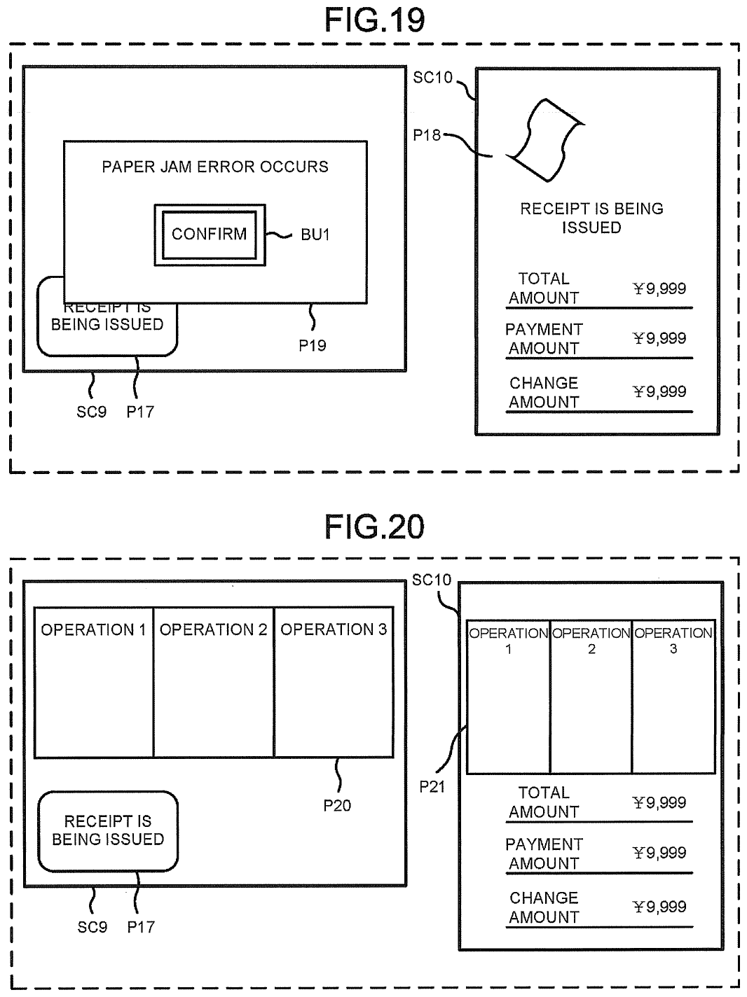

In this state, for example, if a paper jam occurs in the receipt printer 8, the processor 14 recognizes the error as the device error. Thus, the processor 14 executes the processing in Act 52 and Act 53. As a result, as shown in FIG. 19, on the screen SC9 on the touch panel for store clerk 9, an image P19 indicating contents of the error and the confirmation button BU1 are displayed. The screen SC10 on the touch panel for customer 1 does not change.

Therefore, the store clerk can know that the paper jam error occurs in the receipt printer 8 from the image P19 displayed on the screen SC9 on the touch panel for store clerk 9. In this case, the store clerk performs an operation to resolve a paper jam error. However, the paper jam error can only be resolved from the sales floor space SP1 side. Then, after touching the confirmation button BU1, the store clerk moves from the workspace SP2 to the sales floor space SP1 to perform a work to resolve the paper jam error from the sales floor space SP1 side. At this time, since the screen SC10 on the touch panel for customer 1 does not change, the customer does not take any action in response to the device error.

Returning to the description in FIG. 8.

The processor 14 terminating the processing in Act 52 and Act 53 waits for the touch operation on the confirmation button BU1 in Act 54. If the processor 14 detects that the confirmation button BU1 is touched according to the input from the touch panel for store clerk 9, the processor 14 takes Yes in Act 54 and proceeds to the processing in Act 55. The processor 14 determines whether or not the device in which the error occurs is a device on the customer side in Act 55. In the case of the POS terminal 100, the device on the customer side refers to the touch panel for customer 1, the fixed scanner 2, the coin unit 3, the bill unit 4, the credit card reader 5, the near field communication unit 6, the prepaid card reader/writer 7 and the receipt printer 8. For example, the POS terminal 100 stores a data table storing an identification flag in the main storage unit 15 or the auxiliary storage unit 16 in association with a device code for identifying each device. For example, the identification flag is 1-bit information in which “1” is set for a device on the customer side, and “0” is reset for other devices such as the touch panel for store clerk 9, the sub touch panel 10, the keyboard 11 and the hand-held scanner 12. In Act 55, the processor 14 refers to the identification flag in the above-described data table to confirm whether or not the device in which the error occurs is the device on the customer side.

If the device in which the error occurs is the device on the customer side, the processor 14 takes Yes in Act 55 and proceeds to the processing in Act 56. The processor 14 displays images each having contents indicating a work procedure for resolving the error respectively on the screen SC9 on the touch panel for store clerk 9 and the screen SC10 on the touch panel for customer 1 in Act 56.

FIG. 20 shows screens SC9 and SC10 respectively displayed on the touch panel for store clerk 9 and the touch panel for customer 1 after the store clerk touches the confirmation button BU1 on the screen in FIG. 19. As shown in FIG. 20, images P20 and P21 having the contents indicating work procedures for resolving the paper jam error occurring in the receipt printer 8 are respectively displayed on the screens SC9 and SC10 on the touch panel for store clerk 9 and the touch panel for customer 1, respectively.

As described above, when the paper jam error occurs, the store clerk moves to the sales floor space SP1 to perform an operation for resolving the paper jam error. At this time, since the image P21 having the content indicating the work procedures is displayed on the touch panel for customer 1, the store clerk can easily resolve the paper jam error with reference to the image P21. Therefore, the store clerk can perform the error handling work efficiently for the device error occurring in the device on the customer side in the semi-self-service mode.

Returning to the description in FIG. 8.

After terminating the processing in Act 56, the processor 14 stands by until the error is resolved in Act 57. Then, when the processor 14 determines that the error has been resolved according to a signal from the device in which the error occurs, the processor 14 takes Yes in Act 57, and proceeds to the processing in Act 58. The processor 14 erases the image P20 displayed on the screen SC9 on the touch panel for store clerk 9 and the image P21 displayed on the screen SC10 on the touch panel for customer 1 in Act 58. Thus, the processor 14 terminates the information processing executed at the time the device error occurs in the device on the customer side while the POS terminal 100 is operating in the semi-self-service mode.

If the error occurs in a device that is not located on the customer side while the POS terminal 100 is operating in the semi-self-service mode, the processor 14 takes No in Act 55, and proceeds to the processing in Act 59. The processor 14 displays an image having contents indicating work procedures for resolving the device error on the screen SC9 on the touch panel for store clerk 9 in Act 59. After that, the processor 14 stands by until the error is resolved in Act 60. Then, if it is determined that the error is resolved according to a signal from the device in which the error occurs, the processor 14 takes Yes in Act 60 and proceeds to the processing in Act 61. The processor 14 erases the image having contents indicating the work procedures for resolving the device error displayed on the screen SC9 on the touch panel for store clerk 9 in Act 61. Thus, the processor 14 terminates the information processing executed at the time the device error occurs in the device on the store clerk side while the POS terminal 100 is operating in the semi-self-service mode. Therefore, even if the device error occurs in the device on the store clerk side in the semi-self-service mode, the store clerk can perform the error handling work efficiently.

On the other hand, if the device error occurs when “1” is set in the mode flag MF, i.e ., the POS terminal 100 is operating in the full-self-service mode, the processor 14 takes No in Act 51 and proceeds to the processing in Act 62. The processor 14 controls the touch panel for store clerk 9 to display an image having contents for notifying an error in Act 62. The processor 14 controls the touch panel for customer 1 to display an image having contents for instructing to call a store clerk. Furthermore, the processor 14 outputs a drive signal of a warning sound to the buzzer 17 to drive the buzzer 17 in Act 63. The processor 14 arranges a sound stop button BU4 on a part of the screen on the touch panel for store clerk 9 in Act 64.

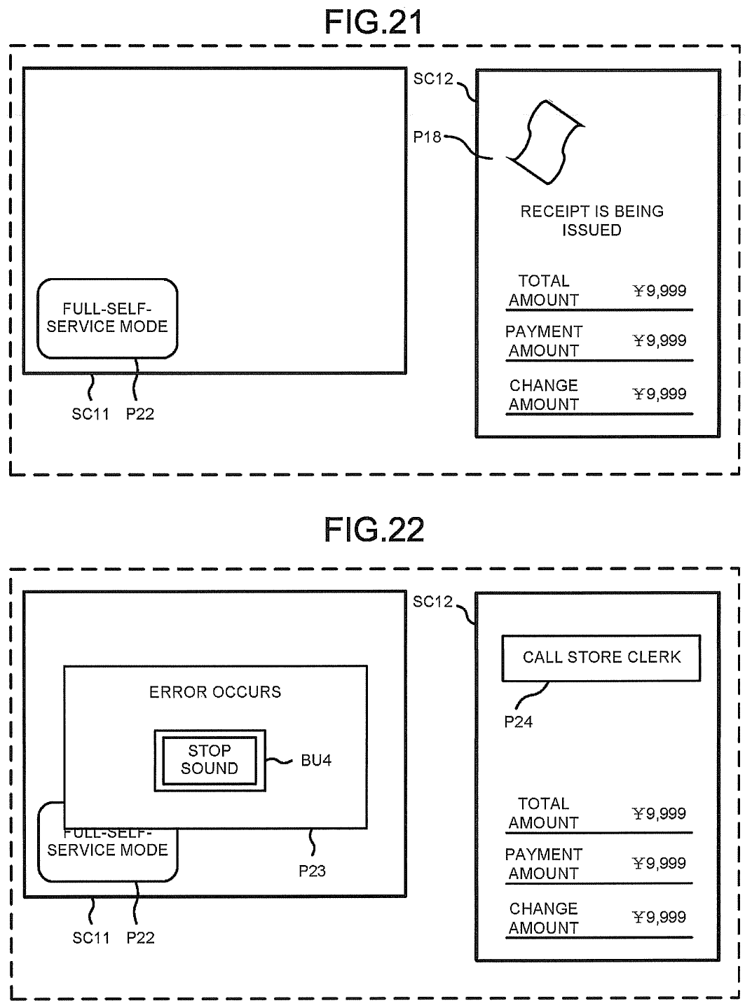

FIG. 21 shows a screen SC11 on the touch panel for store clerk 9 and a screen SC12 on the touch panel for customer 1 when the receipt printer 8 operates to print a receipt as a part of the settlement processing in the POS terminal 100 operating in the full-self-service mode. As shown in FIG. 21, on the screen SC11 on the touch panel for store clerk 9, an image P22 having contents indicating that the POS terminal 100 is in the full-self-service mode is displayed. On the screen SC12 on the touch panel for customer 1, similarly to the semi-self-service mode, an image P18 having contents for notifying the customer that the receipt is being issued is displayed in addition to the total amount, the payment amount and the change amount relating to one transaction.

In this state, for example, if the paper jam occurs in the receipt printer 8, the processor 14 recognizes the error as the device error. Thus, the processor 14 executes the processing in Act 62, Act 63 and Act 64. As a result, as shown in FIG. 22, on the screen SC11 on the touch panel for store clerk 9, an image P23 having contents indicating the occurrence of the error and the sound stop button BU4 are displayed. On the screen SC12 on the touch panel for customer 1, an image P24 having contents for instructing to call the store clerk is displayed.

Therefore, the customer calls the store clerk according to the contents of the image P24. Generally, the store clerk is not present in front of the POS terminal 100 operating in the full-self-service mode. However, since at least one POS terminal 100 is operating in the semi-self-service mode, at least one store clerk is present or operating in the workspace SP2. On the other hand, the store clerk can know that the device error occurs in one of the POS terminals 100 by listening to a warning sound emitted from the buzzer 17. Then, the store clerk called by the customer moves in the workspace SP2. Then, after the store clerk confirms the image P23 having contents indicating the occurrence of the error on the touch panel for store clerk 9, the store clerk touches the sound stop button BU4 displayed on the touch panel for store clerk 9 together with the image P23.

Returning to the description in FIG. 8.

The processor 14 terminating the processing in Act 62, Act 63 and Act 64 waits for the touch operation on the sound stop button BU4 in Act 65. If the processor 14 detects that the sound stop button BU4 is touched according to the input from the touch panel for store clerk 9, the processor 14 takes Yes in Act 65 and proceeds to the processing in Act 66. The processor 14 stops the drive signal output to the buzzer 17 to stop the warning sound in Act 66. After that, the processor 14 proceeds to the processing in Act 52 described above. Then, the processor 14 executes the processing in Act 52 to Act 61 in the same manner as described above. Thus, the processor 14 terminates the information processing executed at the time the device error occurs in the device on the store clerk side while the POS terminal 100 is operating in the full-self-service mode.

Therefore, when the store clerk touches the sound stop button BU4 as a first confirmation operation, the image P23 and the sound stop button BU4 are erased from the screen SC11 on the touch panel for store clerk 9, and the image P19 and the confirmation button BU1 shown in FIG. 19 are newly displayed. In the screen SC12 on the touch panel for customer 1, the image P24 is erased. If the store clerk who confirms that the paper jam error occurs touches the confirmation button BU1 as a second confirmation operation, the images P20 and P21 shown in FIG. 20 are respectively displayed on the screens SC11 and SC12 respectively on the touch panel for store clerk 9 and the touch panel for customer 1. Therefore, the store clerk only needs to move to the sales floor space SP1 to perform an operation for resolving the paper jam error according to the image P21 displayed on the touch panel for customer 1. Therefore, even if the device error occurs in the device on the customer side in the full-self-service mode, the store clerk can perform the error handling work efficiently.

Computer of the POS terminal 100 with the processor 14 as the central component functions as a third control module by executing the processing in Act 51 to Act 56 and the processing in Act 62 in FIG. 8.

As described above in detail, in the POS terminal 100, the screen on the touch panel for store clerk 9, i.e., the first display device, is oriented towards the store clerk side, and the screen on the touch panel for customer 1, i.e., the second display device, is oriented towards the customer side opposite to the store clerk side. Furthermore, the POS terminal 100 can appropriately switch the mode thereof between the semi-self-service mode and the full-self-service mode with the switching module.

In such a POS terminal 100, if the error occurs in the registration operation, an image showing contents of the error is displayed on the touch panel for store clerk 9 at the time the semi-self-service mode is selected. At the time the full-self-service mode is selected, an image for instructing to call a store clerk is displayed on the touch panel for customer 1.

If the error occurs in the settlement operation on the payment amount, at the time the semi-self-service mode is selected, an image indicating the contents of the error is displayed on the touch panel for store clerk 9, and an image for notifying occurrence of the error is displayed on the touch panel for customer 1. At the time the full-self-service mode is selected, an image indicating the contents of the error is displayed on the touch panel for customer 1.

If the error occurs in the device driven in response to the registration operation or the settlement operation on the payment amount, an image indicating the contents of the error is displayed on the touch panel for store clerk 9 at the time the semi-self-service mode is selected. Then, in response to the confirmation operation, an image indicating procedures for resolving the error of the device is displayed on the touch panel for customer 1. At the time the full-self-service mode is selected, an image for instructing to call the store clerk is displayed on the touch panel for customer 1. After that, an image indicating contents of the error is displayed on the touch panel for store clerk 9 in response to the first confirmation operation by the operation on the sound stop button BU4. Then, in response to the second confirmation operation by the operation on the confirmation button BU1, an image indicating procedures for resolving the error of the device is displayed on the touch panel for customer 1.

As described above, if the registration operation error, the settlement operation error or the device error occurs, the contents to be displayed on the touch panel for store clerk 9 and the touch panel for customer 1 are suitably deconstructed depending on whether the semi-self-service mode or the full-self-service mode is selected. Therefore, the store clerk or the customer can carry out the error handling work efficiently.

Although the embodiment of the registration settlement apparatus, which changes a semi-self-service mode and a full-self-service mode, capable of efficiently performing the error handling work is described above, such an embodiment is not limited thereto.

For example, in the above-described embodiment, the POS terminal 100 in which the orientation of the screen on the touch panel for store clerk 9 and the orientation of the screen on the touch panel for customer 1 are opposite to each other is shown; however, the orientations of the screens are not particularly limited as long as the store clerk present on the store clerk side can confirm the screen on the touch panel for store clerk 9 and the customer present on the customer side can confirm the screen on the touch panel for customer 1. Therefore, depending on the situation, the orientation of the screen on the touch panel for store clerk 9 may coincide with the orientation of the screen on the touch panel for customer 1, or the orientations of the screen on the touch panel for store clerk 9 and the screen on the touch panel for customer 1 may different from each other except for the mutually opposite orientations.

In the embodiment described above, the case of emitting the warning sound by the buzzer 17 in Act 63 in FIG. 8 is described, but the warning is not limited to being made by sound. For example, the POS terminal 100 may be provided with a lamp, and the lamp is lit up or blinked to warn the store clerk that the device error occurs. In other words, the warning may be made with light.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A registration settlement apparatus, comprising:
a first display device configured to display to a store clerk;
a second display device configured to display to a customer;
a switching module configured to switch an operation mode of the registration settlement apparatus between a first operation mode in which the store clerk performs registration operation of a commodity that the customer purchases and the customer performs settlement operation on a payment amount of the purchased commodity and a second operation mode in which the customer performs operations of registration of the purchased commodity and settlement on a payment amount of the purchased commodity; and
a control module configured to control the first display device to display an image indicating contents of an error at a time the first operation mode is selected, and control the second display device to display an image for instructions to call the store clerk at a time the second operation mode is selected if the error occurs in the registration operation.

2. The registration settlement apparatus according to claim 1, wherein
orientation of a screen on the second display device is different from that of a screen on the first display device.

3. The registration settlement apparatus according to claim 2, wherein
orientation of the screen on the second display device is opposite to that of the screen on the first display device.

4. The registration settlement apparatus according to claim 1, wherein
the first display device is further configured to display a mode switching button to the store clerk.

5. The registration settlement apparatus according to claim 1, wherein
the error is a registration operation error.

6. The registration settlement apparatus according to claim 1, wherein
the error is a settlement operation error.

7. The registration settlement apparatus according to claim 1, wherein
the registration settlement apparatus is a POS terminal.

8. A registration settlement apparatus, comprising:
a first display device configured to display to a store clerk;
a second display device configured to display to a customer;
a switching module configured to switch an operation mode of the registration settlement apparatus between a first operation mode in which the store clerk performs registration operation of commodity that the customer purchases and the customer performs settlement operation on a payment amount of the purchased commodity and a second operation mode in which the customer performs operations of registration of the purchased commodity and settlement on a payment amount of the purchased commodity; and
a control module configured to control the first display device to display an image indicating contents of an error and control the second display device to display an image for notifying occurrence of the error at a time the first operation mode is selected, and control the second display device to display an image indicating contents of the error at a time the second operation mode is selected.

9. The registration settlement apparatus according to claim 8, wherein
orientation of a screen on the second display device is different from that of a screen on the first display device.

10. The registration settlement apparatus according to claim 9, wherein
orientation of the screen on the second display device is opposite to that of the screen on the first display device.

11. The registration settlement apparatus according to claim 8, wherein
the first display device is further configured to display a mode switching button to the store clerk.

12. The registration settlement apparatus according to claim 8, wherein
the error is a registration operation error.

13. The registration settlement apparatus according to claim 8, wherein
the error is a settlement operation error.

14. The registration settlement apparatus according to claim 8, wherein
the registration settlement apparatus is a POS terminal.

15. A registration settlement apparatus, comprising:
a first display device configured to display to a store clerk;
a second display device configured to display to a customer;
a switching module configured to switch an operation mode of the registration settlement apparatus between a first operation mode in which the store clerk performs registration operation of a commodity that the customer purchases and the customer performs settlement operation on a payment amount of the purchased commodity and a second operation mode in which the customer performs operations from registration of the purchased commodity to settlement on a payment amount of the purchased commodity; and
a control module configured to control the first display device to display an image indicating contents of an error, and then to control the second display device to display an image indicating procedures for resolving the error of a device after reception of a confirmation operation at a time the first operation mode is selected, or to control the second display device to display an image for instructions to call the store clerk, and then control the first display device to display an image indicating contents of the error after reception of a first confirmation operation, and to control the second display device to display an image indicating procedures for resolving the error of the device after reception of a second confirmation operation at the time the second operation mode is selected if the error occurs in a device driven in response to the registration operation or the settlement operation.

16. The registration settlement apparatus according to claim 15, wherein
the control module is configured to issue a warning while displaying an image for instructions to call the store clerk and stop the warning when the first confirmation operation is received at the time the second operation mode is selected.

17. The registration settlement apparatus according to claim 15, wherein
orientation of a screen on the second display device is different from that of a screen on the first display device.

18. The registration settlement apparatus according to claim 17, wherein
orientation of the screen on the second display device is opposite to that of the screen on the first display device.

19. The registration settlement apparatus according to claim 15, wherein
the first display device is further configured to display a mode switching button to the store clerk.

20. The registration settlement apparatus according to claim 15, wherein
the error is a registration operation error or a settlement operation error.
